(19) United States
(12) Patent Application Publication
(10) Pub. No.: US 2010/0067603 A1
(43) Pub. Date: Mar. 18, 2010

(54) Radio Communication Systems And Transmitting Method

(75) Inventor: Hideki FURUDATE, Kawasaki (JP)

Correspondence Address: HANIFY & KING PROFESSIONAL CORPORATION, 1055 Thomas Jefferson Street, NW, Suite 400, WASHINGTON, DC, 20007, US

(73) Assignee: FUJITSU LIMITED, Kawasaki (JP)

(21) Appl. No.: 12/559,364

(22) Filed: Sep. 14, 2009

(30) Foreign Application Priority Data
Sep. 17, 2008 (JP) 2008-238463

(51) Int. Cl. H04B 7/02; H04L 27/12

(52) U.S. Cl. 375/267; 375/302

(57) ABSTRACT

A radio transmitter includes a signal generating unit that generates first and second OFDM (Orthogonal Frequency-Division Multiplexing) signals carrying the same information, and a phase shifter that controls a phase of the second OFDM signal based on a spectrum of a composite signal of the first and second OFDM signals.

### CROSS-REFERENCE TO RELATED APPLICATION

This application is based upon and claims the benefit of priority of the prior Japanese Patent Application No. 2008-238463, filed on Sep. 17, 2008, the entire contents of which are incorporated herein by reference.

### FIELD

Embodiments of the present invention relate to radio communication systems using OFDM (Orthogonal Frequency-Division Multiplexing) communication.

### BACKGROUND

Radio communication is often performed in a multipath environment where a plurality of propagation paths exist for a signal transmitted from an antenna. In this case, different propagation paths have different environments, the strength or phase of the signal that has reached a receiver varies according to the propagation path, resulting in the occurrence of fading. When frequency selective fading occurs, the reception level is lowered at and around a frequency at which the fading occurs, causing degradation in the quality of communication using a frequency domain where the reception level is lowered.

In particular, in OFDM (including OFDMA (Orthogonal Frequency Division Multiplexing Access)) communication, when frequency selective fading occurs, communication quality degradation takes place in the portion of data transmitted by using a subcarrier included in a frequency domain (a notch domain) where the reception level is locally lowered by fading.

To address this fading, an attempt has been made to reduce the number of subcarriers included in a notch domain by narrowing the width of a notch domain of frequency selective fading by applying CSTD (Cyclic Shift Transmit Diversity). FIG. 14 is a diagram explaining an example of a case in which CSTD is applied to a transmitter 1 provided with two transmitting antennas 15 (15a, 15b). Data transmitted by using OFDM is first converted into a time domain signal by an IFFT (Inverse Fast Fourier Transform) processing unit 11. Then, in a signal transmitted from the transmitting antenna 15a, on the data subjected to IFFT, the addition of a CP (cyclic prefix) is performed by a CP adding unit 13 and processing is performed by an RF (Radio Frequency) processing unit 14. On the other hand, a signal from the transmitting antenna 15b, is l generated by performing processing by the CP adding unit 13 and the RF processing unit 14 after adding a fixed delay by a delay processing unit 12 is transmitted. Thus, the signal transmitted from the transmitting antenna 15b is received by a receiver 40 later than the signal transmitted from the transmitting antenna 15a by the delay added by the delay processing unit 12. That is, the direct waves transmitted from the transmitting antennas 15a and 15b produce a pseudo multipath because one of the direct waves is delayed. By generating a pseudo multipath in this way, the number of multipath is increased in a pseudo manner, and the notch width of the frequency selective fading occurring in the actual multipath is narrowed, thereby improving the communication characteristics. Moreover, as related technology, regarding cyclic delay diversity, generating OFDM symbols having different delay periods has been disclosed using cyclic delay diversity.

However, in the diversity to which CSTD is applied, in an environment where the influence of a multipath is small and the influence of fading is small, a pseudo multipath produced by the delay added by the delay processing unit 12 causes frequency selective fading. As a result, in an environment where the influence of the frequency selective fading caused by the actual multipath is small, the frequency selective fading caused by the multipath produced in a pseudo manner by the processing performed by the delay processing unit 12 may conversely degrade the communication characteristics.

### SUMMARY

According to an aspect of the embodiments discussed herein, a signal generating unit that generates first and second OFDM signals carrying the same information, and a phase shifter that controls a phase of the second OFDM signal based on a spectrum of a composite signal of the first and second OFDM signals.

It is to be understood that both the foregoing general description and the following detailed description are exemplary and explanatory and are not restrictive of the embodiments, as claimed.

### BRIEF DESCRIPTION OF DRAWINGS

FIG. 1 is a diagram for explaining an example of the configuration of a transmitter and a receiver which are used in Embodiment (1);

FIGS. 2A to 2E are diagrams for explaining the addition of a cyclic prefix performed by a CP adding unit, respectively;

FIGS. 3A and 3B are diagrams for explaining the influence of CSTD, respectively;

FIG. 4 is a diagram for explaining control of the phase of a signal of a second branch;

FIG. 5 is a diagram explaining an example of a relationship between frequency selective fading characteristics and the signal band of a composite signal;

FIG. 6 illustrates an example of the relationship between frequency selective fading characteristics and the signal band of a composite signal, and a relationship observed after phase control by a phase shifter is performed;

FIG. 7 is a diagram illustrating an example (I) of the calculation result of the influence of frequency selective fading on each subcarrier;

FIG. 8 is a diagram illustrating an example (II) of the calculation result of the influence of frequency selective fading on each subcarrier;

FIGS. 9A to 9C are diagrams for explaining the influence of control of the phase of a second branch on a symbol modulated by QPSK, respectively;

FIG. 10 is a diagram for explaining an example of the configuration of a transmitter and a receiver which are used in Embodiment (2);

FIG. 11 is a diagram for explaining an example of the configuration of a transmitter and a receiver which are used in Embodiment (3);

FIG. 12 is a diagram for explaining an example of the configuration of a transmitter and a receiver which are used in Embodiment (4);

FIG. 13 is a diagram illustrating an example of a relationship between a reception level and a subcarrier number of a pilot subcarrier and

FIG. 14 is a diagram for explaining an example in which CSTD is applied to a transmitter provided with two transmitting antennas.

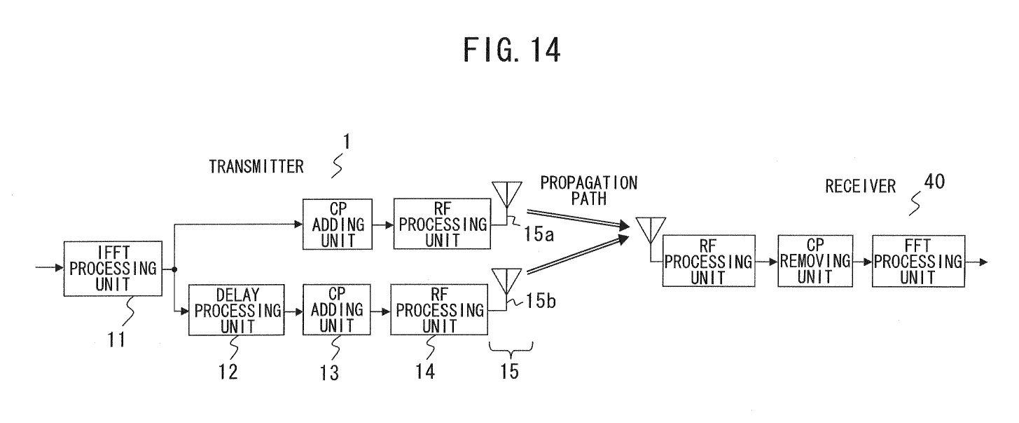

### DESCRIPTION OF EMBODIMENTS

Hereinafter, embodiments will be described in detail with reference to the drawings.

### Embodiment (1)

### Apparatus Configuration

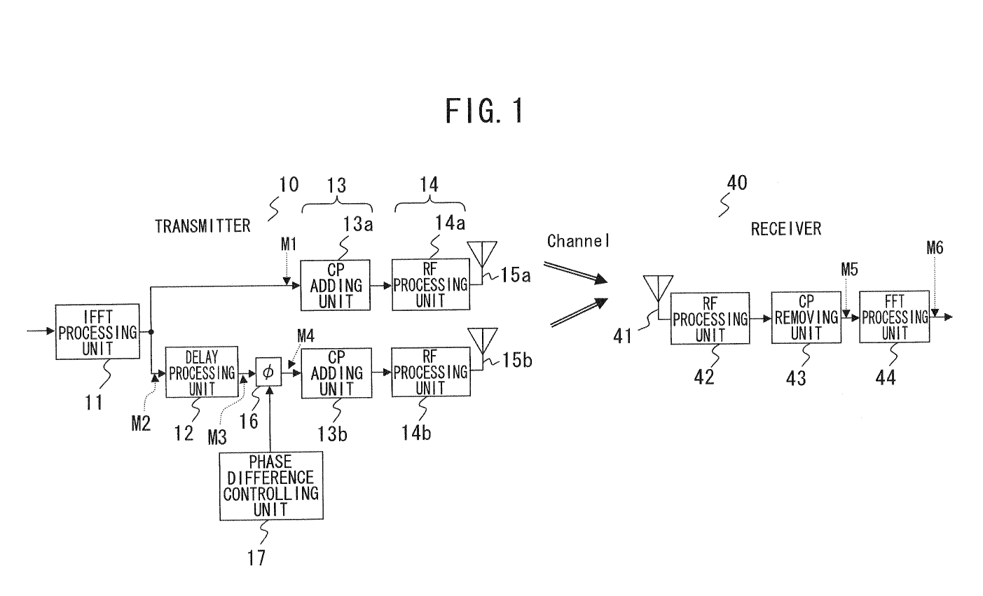

FIG. 1 is a diagram explaining an example of the configuration of a transmitter 10 and a receiver 40 which are used in Embodiment (1). In FIG. 1, the configuration in which OFDM transmission is performed from the transmitter 10 to the receiver 40 is illustrated.

The transmitter 10 includes, in addition to an IFFT processing unit 11, a delay processing unit 12, CP adding units 13 (13a, 13b), RF processing units 14 (14a, 14b), and transmitting antennas 15 (15a, 15b), a phase shifter 16 and a phase difference controlling unit 17.

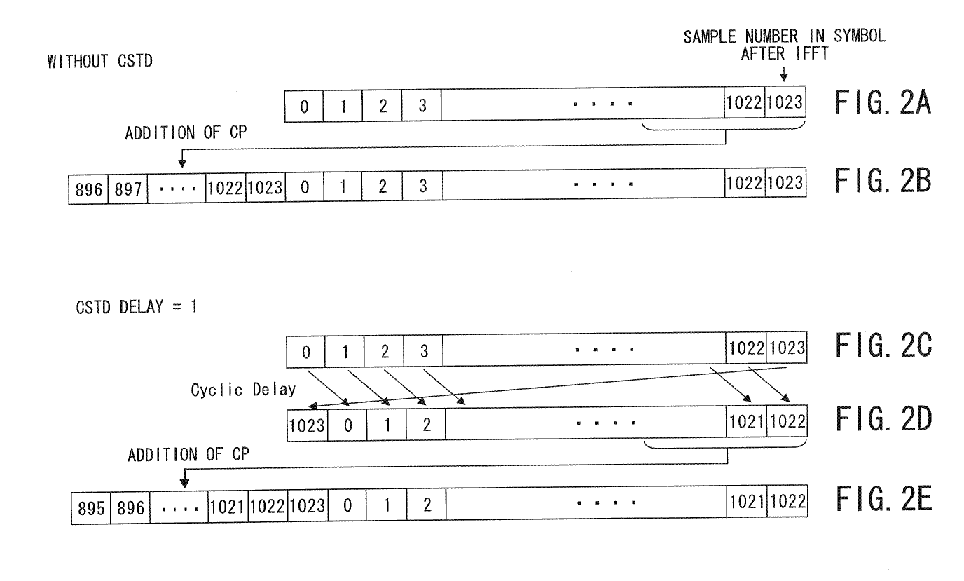

When a complex symbol representing data to be transmitted is inputted, the IFFT processing unit 11 generates a sampled value of a multicarrier signal obtained by combining individual subcarrier signals. A conceptual drawing of data after parallel-serial conversion performed on the generated sampled value is illustrated in FIG. 2A. In the following description, it is assumed that 1024 sampled values are obtained by processing performed by the IFFT processing unit 11, and numbers in FIGS. 2A to 2E indicate the numbers of the sampled values. It is to be noted that, in the present specification and claims, data after parallel-serial conversion performed on a sampled value of a multicarrier signal is also described as an “OFDM signal”.

As exemplified in FIG. 1, after IFFT processing is performed by the IFFT processing unit 11, the OFDM signal is branched into a plurality of branches that generate a signal for transmission. Incidentally, the following description deals with a case, as an example, in which the transmitter 10 has two branches; however, the number of branches may be three or more.

In an example of FIG. 1, a first branch for generating a signal to be transmitted from the transmitting antenna 15a includes the CP adding unit 13a, the RF processing unit 14a, and the transmitting antenna 15a. When the OFDM signal is inputted to the CP adding unit 13a, the CP adding unit 13a adds a cyclic prefix to suppress intersymbol interference of a signal in a propagation path. As illustrated in FIG. 2B, the CP adding unit 13 copies the sampled value at the end of one symbol of the OFDM signal, and adds it to the head of the symbol. Here, the number of sampled values to be added may be arbitrarily changed in accordance with implementation. In an example of FIG. 2B, the 896th to 1023rd sampled values are copied as a cyclic prefix and added to the head of the OFDM signal.

When processing by the CP adding unit 13 is ended, the RF processing unit 14 generates an analog signal by performing D/A conversion on the OFDM signal, and generates a carrier band signal by multiplying the generated analog signal by a carrier. The carrier band signal thus generated is also described as a “carrier band OFDM signal” or an “OFDM signal”. Furthermore, the carrier band OFDM signal is sometimes described as being related to a branch in which the signal has been generated. For example, a carrier band OFDM signal generated in the first branch is also described as a “signal of the first branch”. The transmitting antenna 15a transmits the carrier band OFDM signal generated by the RF processing unit 14a.

On the other hand, a second branch includes, in addition to the CP adding unit 13b, the RF processing unit 14b, and the transmitting antenna 15b, the delay processing unit 12, the phase shifter 16, and the phase difference controlling unit 17. The delay processing unit 12 adds a delay to the inputted OFDM signal (FIG. 2C), thereby generating a signal for reproducing, in a pseudo manner, a state in which the signal of the first branch is transmitted in a multipath environment. As illustrated in FIG. 2D, the delay processing unit 12 shifts the sampled values of the inputted OFDM signal cyclically by a designated amount. In an example of FIG. 2D, since a delay=1, the sequence of the sampled values is changed on a one-by-one basis, whereby the 1023rd sampled value is located at the head, and the 1022nd sampled value is located at the end.

The signal outputted from the delay processing unit 12 is fed to the CP adding unit 13b via the phase shifter 16. Incidentally, the operation of the phase shifter 16 and the phase difference controlling unit 17 will be described later. Upon receipt of the signal to which a delay is added, the CP adding unit 13b performs the addition of a cyclic prefix in the manner as described above (FIG. 2E). As illustrated in FIG. 2D, since a cyclic delay is added to the signal fed to the CP adding unit 13b, when the CP adding unit 13b of the second branch performs the same operation as the CP adding unit 13a of the first branch, a signal of FIG. 2E is outputted. The operation of the RF processing unit 14b and the transmitting antenna 15b is the same as the above-described operation of the RF processing unit 14a and the transmitting antenna 15a of the first branch.

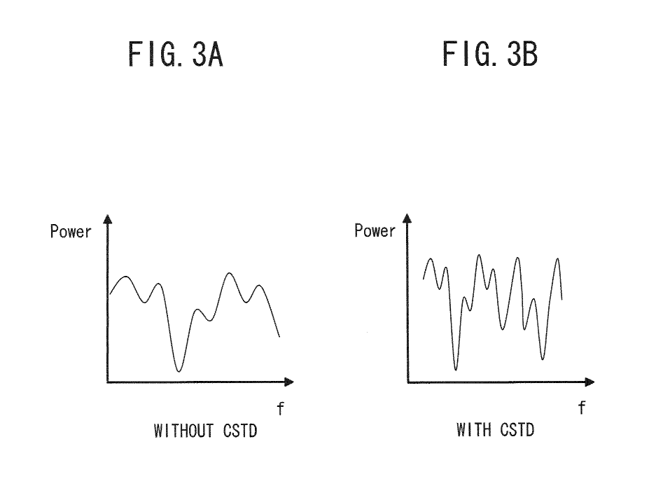

When the signal of the first branch is transmitted from the transmitting antenna 15a and the signal of the second branch is transmitted from the transmitting antenna 15b, the receiver 40 which may communicate with the transmitter 10 receives these signals. FIGS. 3A and 3B are diagrams for explaining the reception level of the signal received by a receiving antenna 41 of the receiver 40 and the influence of CSTD. When a delay has been added to the signal of the second branch by CSTD so that the signal of the second branch lags behind the signal of the first branch, the spectrum of the signal received by the receiving antenna 41 varies as illustrated in FIG. 3B. As illustrated in FIG. 3A, when CSTD is not performed (a delay=0), the reception level varies gently as compared with a case in which CSTD is performed. Therefore, by performing CSTD, it is possible to narrow the width of a domain where the reception level of the signal of the first branch and the signal of the second branch is lowered by frequency selective fading. In other words, it is possible to narrow the width of a notch domain in a reception spectrum, making it possible to reduce the number of subcarriers included in one notch domain.

It is to be noted that a “notch or notch domain” denotes a domain where a signal level is locally lowered relative to a frequency. Therefore, data transmitted by a subcarrier in the notch domain may suffer degradation in communication quality.

Thus, in the transmitter 10, in addition to processing by CSTD, the phase of the signal of the second branch is controlled by the phase shifter 16 and the phase difference controlling unit 17. With this control, it is possible to produce an environment where a notch position in the signal of the first branch and the signal of the second branch, the notch position caused by frequency selective fading, is located outside the signal band of a composite signal of the first and second branches. When the notch domain is located outside the signal band, none of the subcarriers used for transmission of the signals of the first and second branches is included in the notch domain. This makes it possible to avoid degradation in communication quality caused by frequency selective fading. Incidentally, for easier comprehension, the drawings illustrating the spectrum, etc. used in the following description deal with a case in which the number of notch domains in the signal band is small; however, the number of notch domains in the signal band changes according to the situation of a multipath, etc.

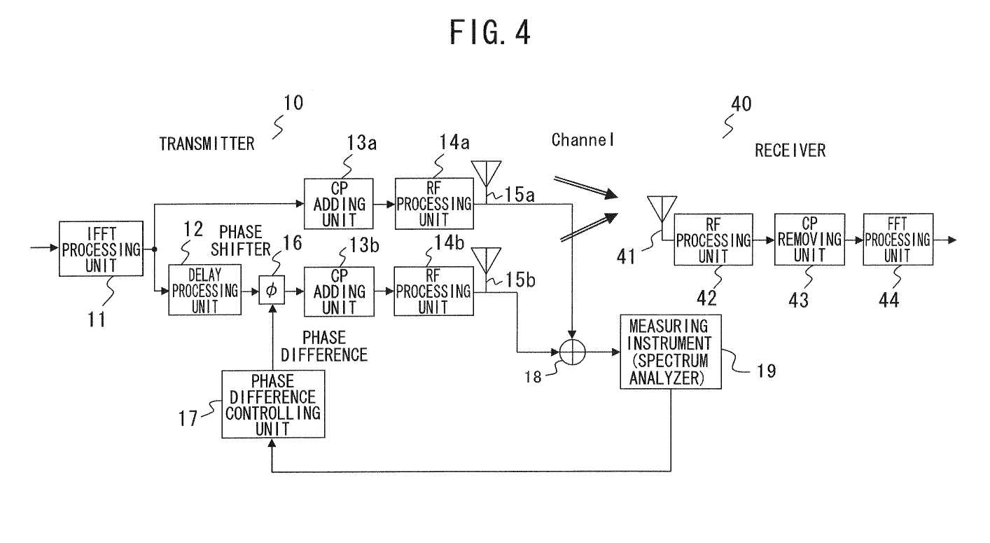

FIG. 4 is a diagram explaining control of the phase of a signal of the second branch. In this embodiment, when phase control is performed, as illustrated in FIG. 4, a mixer 18 and a measuring instrument 19 are provided. The mixer 18 combines a signal of the first branch generated by the RF processing unit 14a and a signal of the second branch generated by the RF processing unit 14b. The composite signal obtained by the mixer 18 is inputted to the measuring instrument 19, and the strength of the composite signal is observed as a function of the frequency. Here, the measuring instrument 19 may be constructed of any device that may indicate the strength of the composite signal as a function of the frequency, and may be built as a spectrum analyzer, for example. Moreover, the measuring instrument 19 may be so constructed as to measure the strength of the composite signal as a function of a number of a subcarrier used for transmitting the carrier band OFDM signal.

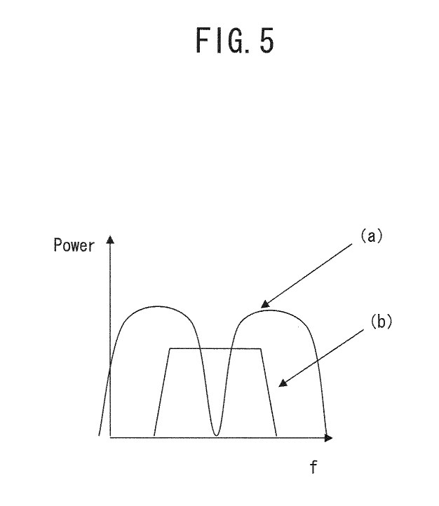

FIG. 5 is a diagram explaining an example of the relationship between frequency selective fading characteristics of the signals of the first and second branches and the signal band of the composite signal. When a spectrum (a) is obtained by the measuring instrument 19 and the signal band is a band indicated by (b), the communication quality is degraded in a subcarrier included in the notch domain located in the central region of the spectrum (a).

In this case, upon receipt of data on the spectrum obtained by the measuring instrument 19, the phase difference controlling unit 17 detects the position of the notch based on the data on the spectrum. At this time, the phase difference controlling unit 17 is appropriately notified of data used for specifying the position of the notch, the data such as the total number (N) of subcarriers and the frequency interval of the subcarriers, by a memory (not illustrated) or the like provided in the transmitter 10. When the notch domain is specified, the phase difference controlling unit 17 calculates a control value of the phase of the signal of the second branch to set the notch domain outside the signal band. The method for calculating a control value of the phase will be described in detail later.

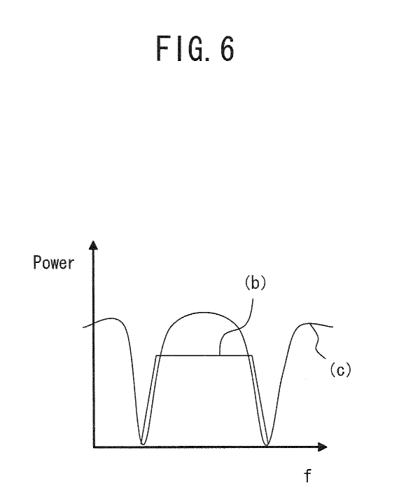

After obtaining the control value of the phase, the phase difference controlling unit 17 notifies the phase shifter 16 of the value. The phase shifter 16 performs control of the phase of the signal of the second branch according to the notified control value. In FIG. 6, an example of the relationship between frequency selective fading characteristics of the signals of the first and second branches and the signal band of the composite signal, the relationship observed after the phase control by the phase shifter 16 is performed, is illustrated. When the control by the phase shifter 16 is performed, as indicated by (c) of FIG. 6, an area in which the signal band and the notch domain overlaps is reduced. As a result, it is possible to avoid the influence of frequency selective fading in most subcarriers and avoid degradation in communication quality caused by frequency selective fading.

Next, the receiver 40 used in this embodiment will be described. As illustrated in FIG. 1 or 4, the receiver 40 includes the receiving antenna 41, an RF processing unit 42, a CP removing unit 43, and an FFT processing unit 44.

The receiving antenna 41 receives a signal from the transmitter 10. In an example illustrated in FIG. 1, the received signal includes first and second branch signals. When the signal is outputted from the receiving antenna 41 to the RF processing unit 42, the RF processing unit 42 down-converts the inputted signal, and then converts an analog signal into a digital signal with an Analog/Digital (A/D) converter. Then, the CP removing unit 43 removes the cyclic prefix from the digital signal. The FFT processing unit 44 performs a fast Fourier transform (FFT) on the data from which the cyclic prefix is removed. Processing such as decoding is performed on the data outputted from the FFT processing unit 44, thereby obtaining the data.

### (Calculation of a Control Value of the Phase)

First, a change of the position of a notch of frequency selective fading, the change caused by changing the phase difference between two carrier band OFDM signals, will be described with a specific example. Incidentally, a monitor point at which a signal described in the following description is observed is illustrated in FIG. 1.

Let an OFDM signal obtained after IFFT processing performed by the IFFT processing unit 11 be g(t). This signal may be observed at a monitor point 1 (M1 in FIG. 1) in front of the CP adding unit 13a of the first branch or in front of the delay processing unit 12 of the second branch (a monitor point M2).

When a delay Δt is added by the delay processing unit 12, a signal g(t+Δt) is generated (a monitor point M3). It is to be noted that, in this embodiment, Δt is determined by the time used to transmit a signal of one symbol and the number of sampled values in one symbol. For example, in an example of FIG. 2D, Δt=1 because the position of each sampled value is changed by one sampled value.

For g(t+Δt), when the phase is changed by φ(rad) by the phase shifter 16, the signal outputted from the phase shifter 16 is given by Expression (1) (a monitor point M4).

e^{j·φ}·g(t+Δt) (1)

As described above, the receiver 40 receives the first and second branch signals. Therefore, when the influence of a propagation path or RF processing on the phase or amplitude of the signal transmitted from the transmitter 10 may be ignored, the signal (the signal observed at a monitor point M5) which has been received by the receiver 40 and then subjected to the removal of the cyclic prefix by the CP removing unit 43 is given by Expression (2).

g(t)+e^{j·φ}·g(t+Δt) (2)

Here, assume that the Fourier transform of g(t) is G(f). In this case, the result of performing a Fourier transform on e^{j·φ}·g(t+Δt) is given by Expression (3).

$${e}^{j \cdot φ} \cdot {e}^{j \cdot 2 π \cdot Δ t \cdot f} \cdot G ( f ) = {e}^{j \cdot 2 π \cdot Δ t \cdot ( f + \frac{φ}{2 π \cdot Δ t } )} \cdot G ( f ) \qquad ( 3 )$$

Therefore, the result (the signal observed at a monitor point M6) obtained by performing a Fourier transform on the composite signal given by Expression (2) is given by Expression (4).

$$G ( f ) + {e}^{j \cdot 2 π \cdot Δ t \cdot ( f + \frac{φ}{2 π \cdot Δ t } )} \cdot G ( f ) = ( 1 + {e}^{j \cdot 2 π \cdot Δ t \cdot ( f + \frac{φ}{2 π \cdot Δ t } )} ) \cdot G ( f ) \qquad ( 4 )$$

That is, when the signals g(t) and e^{j·φ}·g(t+Δt) are transmitted from the transmitter 10 by CSTD, in the receiver 40 which has received both signals, as a result of processing performed by the FFT processing unit 44, as illustrated in Expression (4), a signal obtained by multiplying G(f) by

$$1 + {e}^{j \cdot 2 π \cdot Δ t \cdot ( f + \frac{φ}{2 π \cdot Δ t } )}$$

is obtained.

Here, when the transmitter 10 transmits only the signal g(t) without CSTD, the receiver 40 which has received only the signal g(t) obtains the signal G(f) as a result of processing performed by the FFT processing unit 44. Thus, when the transmitter 10 transmits signals g(t) and e^{j·φ}·g(t+Δt) by CSTD, it may be considered that the receiver 40 receives a signal with a reception level obtained by multiplying, by

$$1 + {e}^{j \cdot 2 π \cdot Δ t \cdot ( f + \frac{φ}{2 π \cdot Δ t } )} ,$$

a reception level observed when only the signal g(t) is received. Consequently, by using a spectrum obtained by expressing the absolute value of

$$1 + {e}^{j \cdot 2 π \cdot Δ t \cdot ( f + \frac{φ}{2 π \cdot Δ t } )}$$

as a function of the frequency, it is possible to calculate the influence of frequency selective fading caused by CSTD and the frequency band included in the notch domain.

The influence of frequency selective fading when the phase control by the phase shifter is not performed is given by Expression (5) by assigning φ=0 (rad) to a coefficient representing the influence of frequency selective fading.

$$1 + {e}^{j \cdot 2 π \cdot Δ t \cdot ( f + \frac{φ}{2 π \cdot Δ t } )} = 1 + {e}^{j \cdot 2 π \cdot Δ t \cdot f } \qquad ( 5 )$$

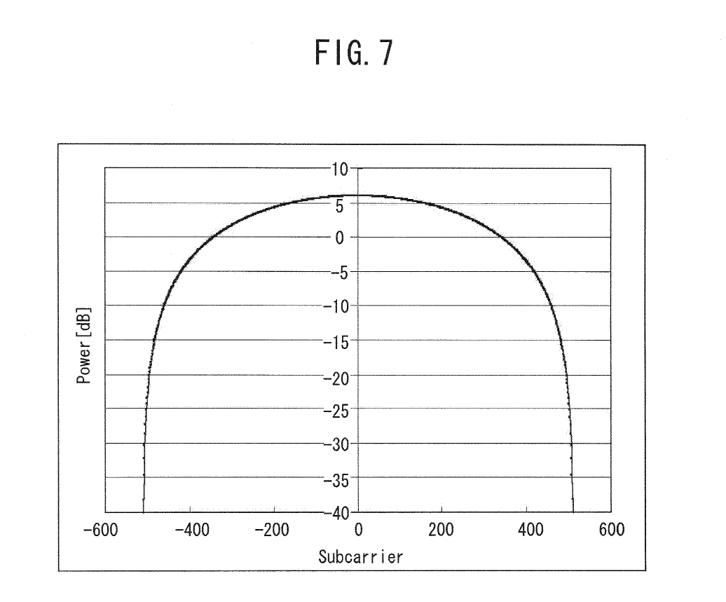

An example (I) of the calculation result of the influence of frequency selective fading on each subcarrier in this case is illustrated in FIG. 7. Here, in FIG. 7, the influence of frequency selective fading on the reception level is expressed as a function of a number of a subcarrier corresponding to a frequency f. FIG. 7 is a spectrum observed when the subcarrier numbers are set to −512 to 511 when the total number (N) of subcarriers used for transmission of the carrier band OFDM signal is 1024. Moreover, the example of FIG. 7 illustrates the result of calculation performed when a delay of one sampled value is added in one symbol of the OFDM signal as illustrated in FIG. 2D. Incidentally, the vertical axis of FIG. 7 represents a reception level (dB). In the example of FIG. 7, when a control value of the phase is 0 (rad), a notch caused by frequency selective fading appears outside the signal band of the carrier band OFDM signal.

Likewise, when a control value φ of the phase controlled by the phase shifter is π/2 (rad) and Δt=1, Expression (6) is obtained.

$$1 + {e}^{j \cdot 2 π \cdot Δ t \cdot ( f + \frac{φ}{2 π \cdot Δ t } )} = 1 + {e}^{j \cdot 2 π \cdot Δ t \cdot ( f + 0.25 ) } \qquad ( 6 )$$

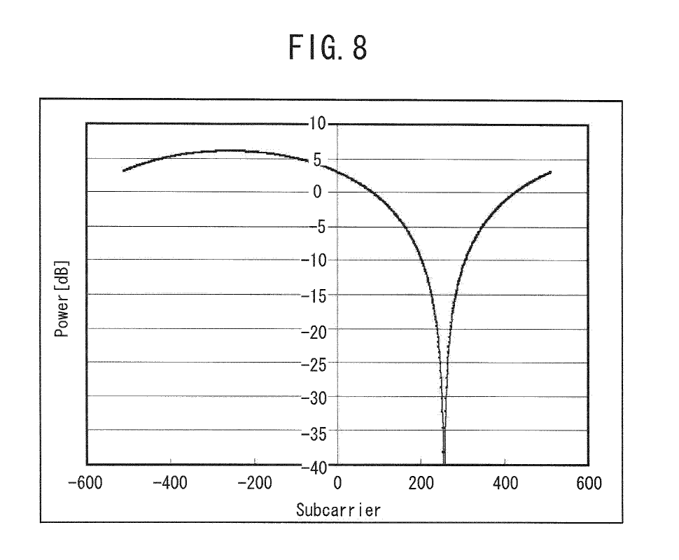

FIG. 8 is a diagram illustrating an example (II) of the calculation result of the influence of frequency selective fading on each subcarrier. In FIG. 8, the influence of frequency selective fading which may be expressed as 1+e^{j·2π·Δt·(f+0.25)} is expressed as a function of a number of a subcarrier corresponding to a frequency f. Moreover, as is the case with the example of FIG. 7, FIG. 8 illustrates the calculated value obtained when 1024 subcarriers whose subcarrier numbers are from −512 to 511 are used and a delay of one sampled value is added by the delay processing unit 12, and when φ is π/2 (rad). The vertical axis represents a signal strength (dB). In the example of FIG. 8, when the phase difference produced by the phase shifter is π/2 (rad), a notch domain caused by frequency selective fading appears in the position of the 256th subcarrier.

The above description illustrated that, by changing the phase difference between the carrier band OFDM signals generated in a plurality of branches by performing phase control among the plurality of branches generating the carrier band OFDM signals, the position of a notch of frequency selective fading was changed.

Next, the relationship between the amount of change in a notch position caused by frequency selective fading and a control value of the phase will be described. Let a control value of the phase of the signal of the second branch be φ, and the total number of subcarriers used for OFDM transmission be N. In this case, the amount of shift Δsubcarrier of a notch domain of frequency selective fading is given by Expression (7).

$$Δ subcarrier = \frac{φ}{2 π \cdot Δ t} \cdot N \qquad ( 7 )$$

Here, Δsubcarrier represents the number of subcarriers of the frequency domain to which the amount of shift of a notch position corresponds. As described above, by performing control of the phase shifter 16 by using φ calculated based on Expression (7) as a control value, it is possible to attain an environment where the notch domain is located outside the signal band.

When the phase shifter 16 is provided with a phase control value Δφ, the phase shifter 16 performs the following control, for example. Incidentally, here, assume that a signal g outputted from the delay processing unit 12 is given by Expression (8).

e^{j·φ}^{₁}·g(t+Δt) (8)

In this case, the phase shifter 16 changes the phase of the signal g from “φ1” to “φ2”. That is, the output signal of the phase shifter 16 is given by Expression (9).

e^{j·φ}^{₂}·g(t+Δt) (9)

Here, “φ2−φ1=Δφ”. Here, the signal g is generally expressed as a digital complex sequence. Therefore, the phase control by the phase shifter 16 corresponds to a computation performed for correcting the value of the real part and the value of the imaginary part of each digital complex number according to the phase control value Δφ.

Incidentally, in the above description, for easier comprehension, an explanation has been given on the assumption that the RF processing unit 14 of the transmitter 10 causes no phase variation. However, in actuality, an oscillator of the RF processing unit 14 sometimes causes phase variation. Moreover, the difference in phase between the RF processing unit 14a of the first branch and the RF processing unit 14b of the second branch, or the like, sometimes produces a phase difference between the signal of the first branch and the signal of the second branch. Also in these cases, by performing control corresponding to a phase difference φ calculated by using the value of N or the like, it is possible to move the notch domain to the outside of the signal band. Furthermore, in the example of FIG. 7, when no phase control is performed and the amount of change in phase in the phase shifter 16 is 0 rad, the notch domain is located outside the signal band. However, this is just an example, and sometimes the notch domain is located in the signal band even when the amount of change in phase in the phase shifter 16 is 0 rad.

### (Change of a Notch Domain by Control of the Phase Shifter)

With reference to FIG. 4, an example of the shifting of a notch domain by performing control of the phase shifter 16 will be described. Assume that the signal of the first branch is g(t) as a result of processing by the CP adding unit 13a and the RF processing unit 14a having been performed on the OFDM signal. Moreover, assume that the signal of the second branch is g(t+Δt) when processing performed by the delay processing unit 12, the phase shifter 16, the CP adding unit 13b, and the RF processing unit 14b on the OFDM signal is finished. Assume that, when a transmitting signal obtained when the transmitting antenna 15a and the transmitting antenna 15b transmit g(t) and g(t+Δt), respectively, and the receiver 40 receives both signals is obtained by the measuring instrument 19, a spectrum illustrated in FIG. 8, for example, is obtained.

When the measuring instrument 19 notifies the phase difference controlling unit 17 of the measurement result, the phase difference controlling unit 17 detects the position of a notch based on the data from the measuring instrument 19. Here, as a notch position detection method adopted by the phase difference controlling unit 17, any known method may be used. For example, a method by which, based on the data on the spectrum measured by the measuring instrument 19, a frequency domain where the signal strength is equal to or lower than a given threshold value is set as a notch position, or a method by which a frequency domain having the smallest value of signal strength in the spectrum data is set as a notch position may be used. Moreover, it is also possible to monitor the amount of change in signal strength and designate a domain where the signal strength takes a minimum value in a given frequency width as a notch domain.

For example, assume that the phase difference controlling unit 17 detects that a center of a notch is located in the 256th subcarrier of 1024 subcarriers numbered −512 through 511. Then, the phase difference controlling unit 17 calculates a control value of the phase according to the above-described method. For example, assume that the phase difference controlling unit 17 sets Δsubcarrier at 256 so that the central position of the notch is located in a high frequency position higher than the 511th subcarrier by a frequency used in one subcarrier. Since Expression (7) may be transformed as follows, a value of φ for making the amount of shift of the notch domain correspond to 256 subcarriers when Δt=1 is calculated by Expression (10).

$$φ = \frac{Δ subcarrier}{N} \cdot 2 π \cdot Δ t = \frac{256}{1024} \cdot 2 π \cdot 1 = \frac{π}{2} \qquad ( 10 )$$

Therefore, in this case, the phase difference controlling unit 17 calculates that it is possible to locate a notch domain of frequency selective fading outside the signal band by changing the difference in phase between the signal of the first branch and the signal of the second branch by π/2.

When the phase difference controlling unit 17 notifies the phase shifter 16 that a control value is π/2, the phase shifter 16 changes the phase of the signal of the second branch by π/2. In this way, as illustrated in FIG. 7, it is possible to attain an environment where the notch domain of frequency selective fading is located outside the signal band. This makes it possible to alleviate degradation in communication quality caused by frequency selective fading in all subcarriers used in the carrier band OFDM signal.

Incidentally, the phase difference controlling unit 17 may also be so configured as to determine Δsubcarrier based on the number of subcarriers included between a subcarrier included in the notch domain and a subcarrier located at the end of the signal band. For example, when the central position of the notch is the 256th subcarrier and the high-frequency side end of the signal band is the 511th subcarrier, it is possible to calculate a control value for shifting the notch domain by 255 subcarriers corresponding to the difference between the two subcarriers.

### (Processing at a Receiving End)

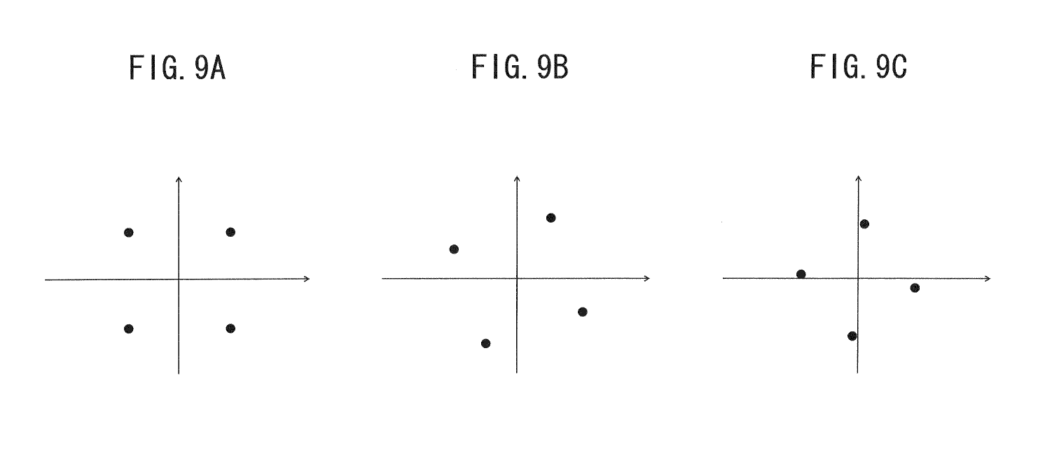

Reconstitution of data performed in the receiver 40 that has received a signal of the second branch, the signal subjected to phase control, and a signal of the first branch as described above will be described. FIGS. 9A to 9C are diagrams for explaining the influence of the phase control of the second branch on a symbol modulated by QPSK (Quadrature Phase Shift Keying). Assume that a signal is generated in the transmitter 10 with signal points illustrated in FIG. 9A, the signal points forming each symbol.

At this time, assume that a signal generated by the IFFT processing unit 11 of the transmitter 10 is expressed by g(t). When the phase is not changed by the phase shifter 16 in the second branch, a signal g(t+Δt) illustrated at the monitor point M3 of FIG. 1 is transmitted from the second branch. Here, when the Fourier transform of g(t) is G(f), the Fourier transform of g(t+Δt) is given by e^{j·2πΔt·f}·G(f). Therefore, when processing by the FFT processing unit 44 is finished in the receiver 40, a signal given by Expression (11) which is the Fourier transform of g(t)+g(t+Δt) is obtained.

G(f)+e^{j·2π·Δt·f}·G(f)=(1+e^{j·2π·Δt·f})·G(f) (11)

As is clear from Expression (11), since G(f) is multiplied by distortion 1+e^{j·2π·Δt·f} caused by a multipath, the signal points change as illustrated in FIG. 9B, for example.

When the phase is changed by only φ by the phase shifter 16, in the receiver 40, as illustrated in Expression (4) described above, a signal obtained by multiplying G(f) by

$$1 + {e}^{j \cdot 2 π \cdot Δ t \cdot ( f + \frac{φ}{2 π \cdot Δ t } )}$$

is obtained by processing performed by the FFT processing unit 44. Thus, it may be considered that, in addition to a change in the positions of the signal points due to the influence of the multipath caused by CSTD when no phase control is performed, the influence of phase control makes the signal points change as illustrated in FIG. 9C, for example.

The transmitter 10 generates a signal by using the signal points illustrated in FIG. 9A. However, when the signal is received by the receiver 40, the placement of the signal points is changed as illustrated in FIG. 9C. Thus, the receiver 40 performs decoding by estimating a change in the signal points by using a pilot signal.

As described above, even when control of the phase of a signal is performed, as is the case with the influence of a pseudo multipath using a delay by CSTD, the influence on the transmitted symbol appears as amplitude distortion and phase distortion. Therefore, the influence of phase control in the transmitter 10 is observed as just a change in the placement of the signal points when the signal is decoded in the receiver 40. That is, in the constellations illustrated in FIGS. 9A to 9C, phase control is observed as a change in the placement of the signal points. This makes it possible to perform data reconstitution on the signal subjected to phase control by using a pilot signal, and decode the signal from the transmitter 10 in any receiver supporting OFDM communication.

However, as is clear from the fact that, in a coefficient illustrated in Expression (4), etc., the coefficient representing the influence of frequency selective fading, φ/(2π·Δt) is added to a frequency f, a phase difference φ in the time domain after IFFT corresponds to a frequency shift in the frequency domain after FFT. That is, while the frequency of the received signal does not change as illustrated in Expression (11) in the generation of a multipath using a delay by CSTD, the frequency of the received signal is changed when phase control is performed.

As described above, by performing phase control in a portion of a plurality of branches in the transmitter 10, it is possible to make a notch domain in the reception level in the receiver 40 appear outside the signal band. This makes it possible to avoid degradation in the quality of communication using a subcarrier included in the notch domain, and thereby improve the communication quality.

Such a transmitter 10 may prevent degradation in communication quality caused by a multipath produced in a pseudo manner by CSTD in an environment where a multipath is less likely to be produced and the influence of frequency selective fading is small. Examples of the environment where a multipath is less likely to be produced and the influence of frequency selective fading is small include, for example, an environment where almost no obstacles exist between the transmitter 10 and the receiver 40 and both the transmitter 10 and the receiver 40 remain stationary and an environment where few obstacles exist and a multipath is less likely to be produced; however, the environment is not limited thereto.

Moreover, in the transmitter 10, for frequency selective fading caused by an actual multipath, by narrowing the width of a notch domain by performing CSTD, it is possible to avoid degradation in communication characteristics caused by frequency selective fading. Therefore, according to the transmitter 10, when the influence of a multipath is great, it is possible to avoid degradation in communication characteristics by using CSTD; when the influence of a multipath is small, it is possible to avoid the influence of a pseudo multipath produced by CSTD by performing phase control. That is, the use of the transmitter 10 makes it possible to avoid degradation in communication quality caused by the influence of frequency selective fading that may occur in various communication environments.

### Embodiment (2)

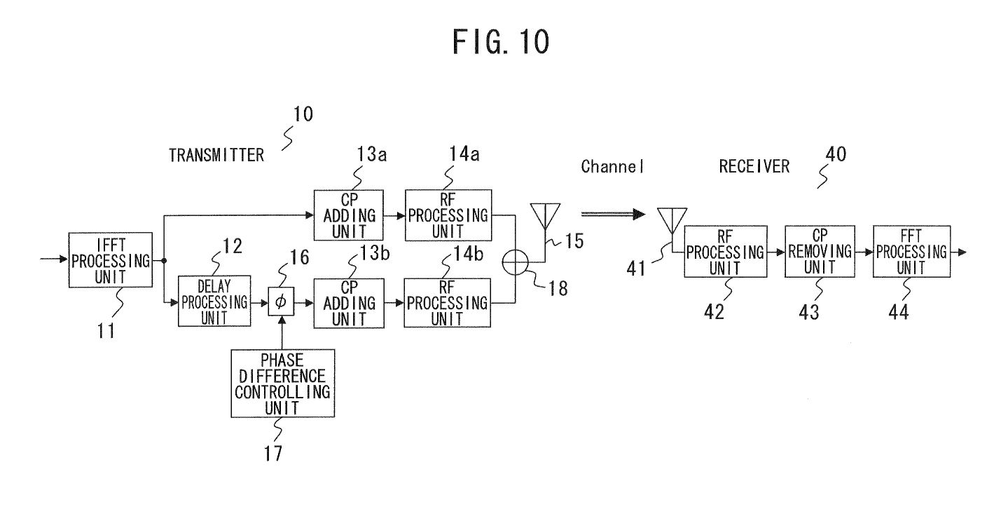

FIG. 10 is a diagram explaining an example of the configuration of a transmitter and a receiver used in Embodiment (2). As in Embodiment (1), the transmitter 10 includes an IFFT processing unit 11, a delay processing unit 12, CP adding units 13 (13a, 13b), RF processing units 14 (14a, 14b), a phase shifter 16, and a phase difference controlling unit 17; however, the transmitter 10 differs therefrom in that it includes one transmitting antenna 15. Moreover, the transmitter 10 includes a mixer 18 for combining a signal of a first branch and a signal of a second branch.

As illustrated in FIG. 4, the output from the mixer 18 is inputted to a measuring instrument 19, and a spectrum is measured by using the measuring instrument 19, whereby the relationship between frequency selective fading characteristics and the signal band of a composite signal is determined. When a notch domain caused by frequency selective fading is located in the signal band, by the method described in Embodiment (1), the phase difference controlling unit 17 calculates a control value of the phase, and the phase shifter 16 performs phase control.

The configuration of a receiver 40 receiving a signal transmitted from the transmitting antenna 15 is the same as that of the receiver 40 described in Embodiment (1).

With this configuration, the position of a notch of frequency selective fading is fixed irrespective of the positional relationship between a transmitting antenna and a terminal. As a result, since the position of a notch is fixed irrespective of the positional relationship between a transmitting antenna and a terminal, it becomes easier to control the position of a notch by phase control.

### Embodiment (3)

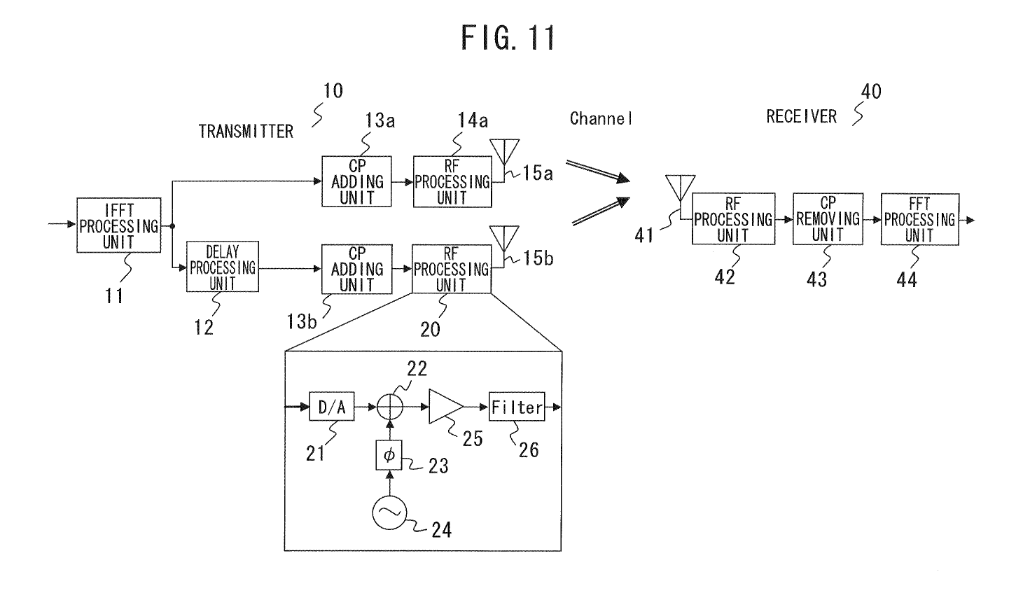

FIG. 11 is a diagram explaining an example of the configuration of a transmitter and a receiver used in Embodiment (3). In Embodiments (1) and (2), the phase shifter 16 is placed between the delay processing unit 12 and the CP adding unit 13; in this embodiment, the phase shifter 16 is incorporated into an RF processing unit 20. The RF processing unit 20 of Embodiment (3) includes a D/A converter 21, a mixer 22, a phase shifter 23, an oscillator 24, an amplifier 25, and a filter 26.

The D/A converter 21 converts a sampled value string inputted to the RF processing unit 20 into an analog signal, and outputs the analog signal. The mixer 22 multiplies the signal by a carrier for performing up-conversion with the oscillator 24. The amplifier 25 amplifies the signal where appropriate, and the filter 26 removes unnecessary noise.

Although the phase shifter 23 performs phase control in the same manner as the phase shifter 16 described in Embodiment (1), the phase shifter 23 differs therefrom in that it includes both the phase difference controlling unit 17 and the phase shifter 16. Therefore, the phase shifter 23 calculates a control value of the phase according to data notified from the measuring instrument 19, and performs phase control in accordance with the calculation result. In this case, the phase shifter 23 controls the phase of a carrier signal generated by the oscillator 24, for example. It is to be noted that the measuring instrument 19 may be placed as illustrated in FIG. 4.

Incidentally, although the phase shifter may be placed in a position illustrated as the phase shifter 16 or the phase shifter 23, it is also possible to place the phase shifter in any position where it may perform control on the data subjected to IFFT processing by the IFFT processing unit 11. For example, the phase shifter may also be placed between the IFFT processing unit 11 and the delay processing unit 12 and between the CP adding unit 13 and the RF processing unit 20 or the RF processing unit 14. Also in these cases, it is possible to place the phase difference controlling unit 17 appropriately in a position where the phase difference controlling unit 17 may notify the phase shifter of a control value. Moreover, as is the case with the phase shifter 23, it is also possible to place the phase difference controlling unit 17 including both the phase shifter 16 and the phase difference controlling unit 17.

### Embodiment (4)

In Embodiments (1) to (3) described above, the measuring instrument 19 is connected to the transmitter 10, and the position of a notch is adjusted based on the measurement result obtained by the measuring instrument 19. However, it is also possible to control the notch position by making a transmitter 30 receive the feedback result from a receiver 50.

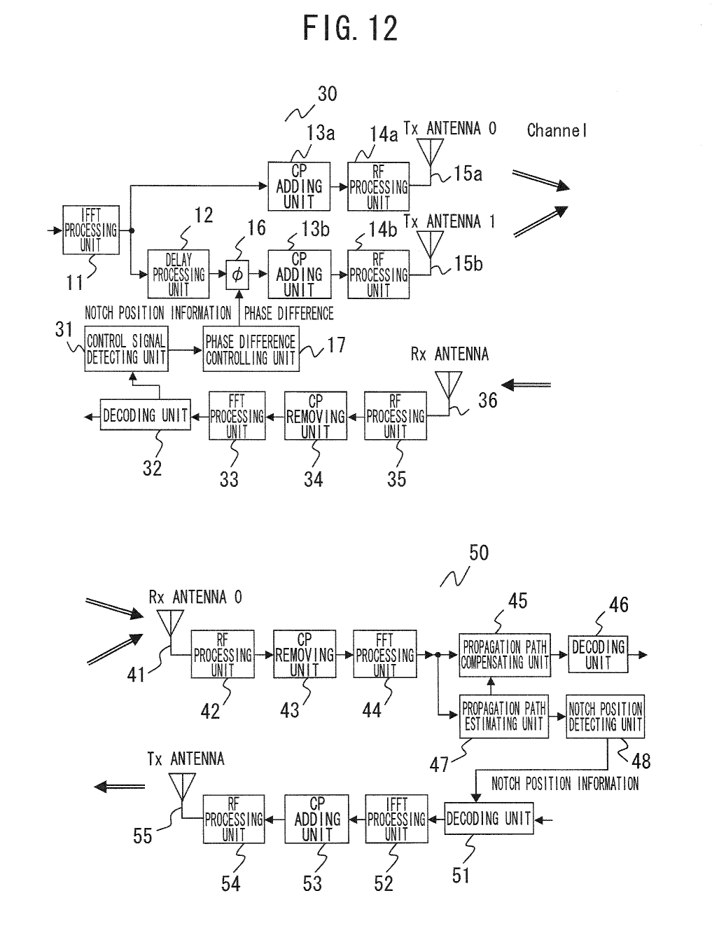

FIG. 12 is a diagram explaining an example of the configuration of the transmitter 30 and the receiver 50 when the notch position is controlled by using the feedback result from the receiver 50. The transmitter 30 includes, as is the case with the transmitter 10 used in other embodiments, an IFFT processing unit 11, a delay processing unit 12, CP adding units 13, RF processing units 14, transmitting antennas 15, a phase shifter 16, and a phase difference controlling unit 17, and, in addition to them, includes a receiving unit. The receiving unit includes a control signal detecting unit 31, a decoding unit 32, an FFT processing unit 33, a CP removing unit 34, an RF processing unit 35, and a receiving antenna 36.

On the other hand, the receiver 50 includes a transmitting unit in addition to a receiving antenna 41, an RF processing unit 42, a CP removing unit 43, an FFT processing unit 44, a propagation path compensating unit 45, a decoding unit 46, a propagation path estimating unit 47, and a notch position detecting unit 48. Here, the transmitting unit is used not only for transmitting information on the position of the notch detected by the notch position detecting unit 48 to the transmitter 30, but also for transmitting any other information. The transmitting unit includes a coding unit 51, an IFFT processing unit 52, a CP adding unit 53, an RF processing unit 54, and a transmitting antenna 55.

Of the transmitter 30, the operation of the IFFT processing unit 11, the delay processing unit 12, the CP adding units 13, the RF processing units 14, and the transmitting antennas 15 (15a, 15b) is the same as the operation described in Embodiment (1). The operation performed by the receiving antenna 41, the RF processing unit 42, the CP removing unit 43, and the FFT processing unit 44 after signals transmitted from the transmitting antennas 15a and 15b are received by the receiving antenna 41 of the receiver 50 is also the same as the operation described in Embodiment (1).

When a time domain signal is converted into a frequency domain signal by processing performed by the FFT processing unit 44, the propagation path estimating unit 47 specifies the position of a pilot subcarrier of the subcarriers included in the signal band. The propagation path estimating unit 47 further estimates the influence of a pseudo multipath and the magnitude of distortion of the phase and amplitude, the distortion occurring in the propagation path, by using data on the specified pilot subcarrier, and notifies the propagation path compensating unit 45 of the estimation result. That is, the propagation path estimating unit 47 estimates a change in the placement of the signal points for decoding the data transmitted from the transmitter 30, and notifies the propagation path compensating unit 45 of the estimation result. Based on the information thus notified, the propagation path compensating unit 45 compensates for a change in the signal points on the constellation map, and outputs the obtained result to the decoding unit 46. Based on the information inputted from the propagation path compensating unit 45, the decoding unit 46 decodes the data transmitted from the transmitter 30.

In addition to outputting the information to the propagation path compensating unit 45, the propagation path estimating unit 47 notifies the notch position detecting unit 48 of the position of the specified pilot subcarrier. Here, the “position of a subcarrier” denotes a subcarrier number of a subcarrier whose position is to be specified, or the frequency used by a subcarrier whose position is to be specified. That is, when a carrier band OFDM signal is expressed by the frequency domain, the information indicating to which domain of the carrier band OFDM signal a subcarrier whose position is to be specified corresponds is referred to as the “position of a subcarrier”. Therefore, for example, the propagation path estimating unit 47 notifies the notch position detecting unit 48 of the position of the pilot subcarrier as a subcarrier number.

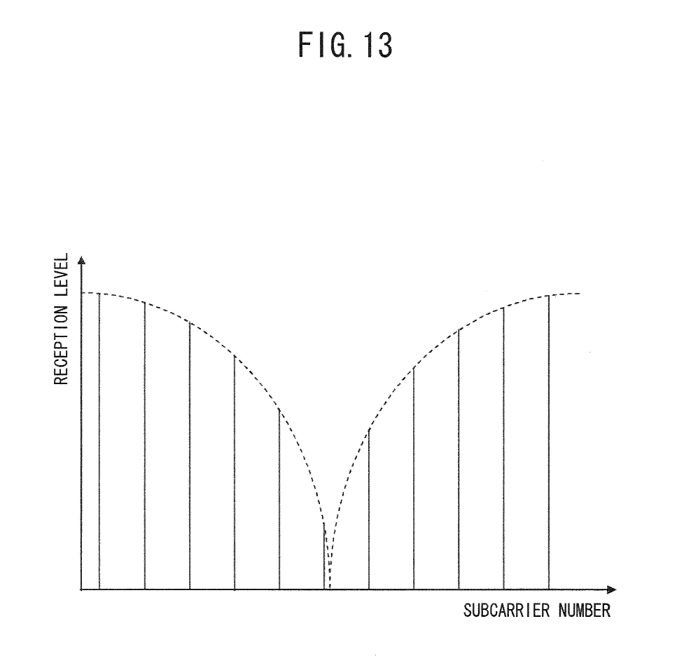

The notch position detecting unit 48 measures the strength of the pilot subcarrier by using the position of the pilot subcarrier thus notified, and specifies the position of the notch based on the relationship between the reception level of the signal transmitted by the pilot subcarrier and the position of the pilot subcarrier. FIG. 13 is an example of a diagram illustrating the relationship between the reception level and a subcarrier number of the pilot subcarrier. In FIG. 13, the strength of the pilot subcarrier is indicated by solid lines. The notch position detecting unit 48 checks the relationship between the reception level and the position of the pilot subcarrier illustrated in FIG. 13, and estimates the reception strength of a signal of each subcarrier by connecting the strength of the pilot subcarrier as indicated by dashed lines in FIG. 13. Based on the estimation result, the notch position detecting unit 48 detects a subcarrier number of the smallest value of the reception strength as a notch position, and notifies the coding unit 51 of the number for giving feedback to the transmitter 30. It is to be noted that, in the present specification and claims, information detected by the notch position detecting unit 48 for specifying the notch domain is also described as “notch position information”.

The coding unit 51 encodes the notch position information to be transmitted from the receiver 50 to the transmitter 30. Incidentally, when the notch position information is transmitted from the receiver 50 to the transmitter 30 along with other information, it is encoded along with the other information to be transmitted from the receiver 50. When the encoded data is inputted to the IFFT processing unit 52, the data is converted from a frequency domain signal into a time domain signal by IFFT processing, and is outputted to the CP adding unit 53. To the outputted signal, a cyclic prefix is added by the CP adding unit 53, and the signal is converted from a digital signal into an analog signal by the RF processing unit 54 and is up-converted into a carrier band, and is then transmitted from the transmitting antenna 55 to the transmitter 30.

The receiving antenna 36 receives the signal transmitted from the transmitting antenna 55, and outputs the received signal to the RF processing unit 35. The RF processing unit 35 down-converts the inputted signal, thereby converting the signal from an analog signal into a digital signal. The digital signal generated by the RF processing unit 35 is outputted to the CP removing unit 34, and, after the cyclic prefix is removed therefrom by the CP removing unit 34, the signal is subjected to FFT processing by the FFT processing unit 33, and is converted into a frequency domain signal. The frequency domain signal outputted from the FFT processing unit 33 is decoded by the decoding unit 32 on a subcarrier-by-subcarrier basis. The data decoded by the decoding unit 32 is outputted to the control signal detecting unit 31, and the control signal detecting unit 31 detects data on the notch position information.

When detecting the notch position information, the control signal detecting unit 31 outputs the notch position information to the phase difference controlling unit 17. The phase difference controlling unit 17 calculates a control value of the phase shifter 16, as described in Embodiment (1), by using a subcarrier number of the notch domain specified by the notch position information, and the phase shifter 16 controls the phase of the signal of the second branch according to the calculated control value.

With this configuration, in Embodiment (4), the transmitter 30 may perform control of the phase of the second branch while performing communication between the transmitter 30 and the receiver 50. Therefore, as compared with Embodiments (1) to (3), Embodiment (4) has the advantage that it is capable of responding to a change in a communication environment. Moreover, as is the case with Embodiment (1), when the influence of an actual multipath is great, it is possible to avoid degradation in communication characteristics by using CSTD; when the influence of the multipath is small, it is possible to avoid the influence of a pseudo multipath produced by CSTD by controlling the phase. Thus, in a system incorporating the receiver 50, it is possible to avoid degradation in communication quality caused by the influence of frequency selective fading that may occur in various communication environments.

Incidentally, the notch position detecting unit 48 may also specify the notch position by a method different from that described above. For example, the notch position detecting unit 48 may be so configured as to set the position of a subcarrier where the reception level takes a minimum value as a notch position when the reception level is expressed as a function of a subcarrier. Moreover, the notch position detecting unit 48 may also be so configured as to set the position of a subcarrier where the reception level becomes a value smaller than a fixed threshold value as a notch position. Furthermore, the notch position detecting unit 48 may also be so configured as to provide notification of the notch position not only by using a subcarrier number but also by designating a frequency band.

Moreover, in Embodiment (4), the phase difference controlling unit 17 may be so configured as to check whether the notch domain is located outside the signal band by receiving feedback from the receiver 50 again after the phase of the signal of the second branch is controlled.

Furthermore, the receiver 50 may be so configured as to calculate a control value of the phase and notify the transmitter 30 of the calculation result. In this case, the notch position detecting unit 48 operates as a control value calculating unit, and calculates a control value of the phase for achieving an environment where the notch domain is located outside the signal band. The transmitter 30 is notified of the control value calculated by the control value calculating unit in the same method as that of the notch position information obtained by the notch position detecting unit 48.

According to the embodiments described above, degradation in communication characteristics caused by frequency selective fading is avoided.

### <Other>

It is to be noted that the present invention is not limited to the embodiments described above, and many modifications of the present invention are possible. A few examples will be described below.

### (Control of a Phase Difference in the First and Second Branches)

For example, phase control may also be performed in both the first and second branches. As described above, a control value calculated by the phase difference controlling unit 17 is the amount of change in the difference in phase between a signal of the first branch and a signal of the second branch. Therefore, when the amount of change in phase of the signal of the second branch is greater than the amount of change in the phase of the signal of the first branch, and the difference in amount of change in the two branches is equal to a control value, it is possible to perform phase control in the same manner as the embodiments described in Embodiments (1) to (4). In this case, both the first branch and the second branch may be provided with the phase shifter 16 and the phase difference controlling unit 17.

### (Control of a Phase Shifter by an Operator)

The above description deals with a configuration in which control of the phase shifter 16 is performed in such a way that the phase shifter 16 autonomously performs phase control according to a control value calculated by the phase difference controlling unit 17. However, an operator may adjust the phase shifter 16 according to a control value outputted from the phase difference controlling unit 17. Moreover, when the operator adjusts the phase shifter 16, it is possible to adopt a configuration in which the transmitter 10 includes no phase difference controlling unit 17 in Embodiments (1) to (3). In this case, the operator operates the phase shifter 16 based on the relationship between the signal level measured by the measuring instrument 19 and the frequency or subcarrier number. Incidentally, to make it easy for the operator to adjust the phase shifter 16, it is also possible to adopt a configuration in which the measuring instrument 19 is provided with a display unit so that a spectrum representing the relationship between the measured signal level and the frequency or subcarrier number is displayed on the display unit.

### (Modified Example of Calculation of a Control Value of a Phase Shifter)

The phase difference controlling unit 17 may be provided with a delay value by CSTD in addition to notch position information from the receiver or spectrum information of the measuring instrument 19 and the total number N of subcarriers. When the phase difference controlling unit 17 is notified of a delay value by CSTD, even when a delay value added by the delay processing unit 12 is changed, it is possible to calculate a control value of the phase by using the notified delay value. Thus, even when the delay value changes over time, it is possible to calculate a control value of the phase accurately, the control value for moving a notch domain in a spectrum of a composite signal from two branches to the outside of the signal band.

### (Modified Example of the Number of Branches)

The above-described embodiments deal with cases in which the number of branches is two; however, an OFDM signal may be branched into an arbitrary number of branches after the completion of IFFT processing. When phase processing is performed by branching the OFDM signal into three or more branches, it is possible to move a notch position in a composite signal of signals from the branches to the outside of the signal band by appropriately performing phase control on each branch by using two or more phase shifters.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A radio transmitter comprising:
a signal generating unit that generates first and second OFDM (Orthogonal Frequency-Division Multiplexing) signals carrying the same information; and
a phase shifter that controls a phase of the second OFDM signal based on a spectrum of a composite signal of the first and second OFDM signals.

2. The radio transmitter according to claim 1, further comprising:
a phase difference controlling unit that calculates a control value of the phase of the second OFDM signal based on a frequency at which a notch in the spectrum of the composite signal appears,
wherein the phase shifter controls the phase of the second OFDM signal according to the control value of the phase, the control value being calculated by the phase difference controlling unit.

3. The radio transmitter according to claim 1, further comprising:
a phase difference controlling unit that calculates a control value of the phase of the second OFDM signal so that a notch in the spectrum of the composite signal is located outside a signal band of the OFDM signal,
wherein the phase shifter controls the phase of the second OFDM signal according to the control value of the phase, the control value being calculated by the phase difference controlling unit.

4. The radio transmitter according to claim 1, further comprising:
a phase difference controlling unit that calculates a control value of the phase of the second OFDM signal as a function of a number of subcarriers included between a first subcarrier included in a notch in the spectrum of the composite signal and a second subcarrier using a frequency at an end of a signal band used for transmission of the composite signal,
wherein the phase shifter controls the phase of the second OFDM signal according to the control value of the phase, the control value being calculated by the phase difference controlling unit.

5. The radio transmitter according to claim 1,
wherein a signal obtained by combining the first OFDM signal and the second OFDM signal is transmitted from one antenna.

6. The radio transmitter according to claim 1, further comprising:
a cyclic prefix adding unit that adds a cyclic prefix to at least one OFDM signal,
wherein the phase shifter controls the phase of the second OFDM signal before the cyclic prefix is added.

7. The radio transmitter according to claim 1, comprising:
a radio-frequency processing unit, wherein
the phase shifter is provided between an oscillator and a mixer included in the radio-frequency processing unit, and
the phase shifter controls the phase of the second OFDM signal by adjusting a phase of an output signal of the oscillator.

8. The radio transmitter according to claim 1, further comprising:
a receiving unit that receives notch position information representing a frequency at which a notch in the spectrum of the composite signal appears, the notch position information being detected by a radio receiver which has received the first and second OFDM signals; and
a phase difference controlling unit that calculates a control value of the phase of the second OFDM signal based on the notch position information,
wherein the phase shifter controls the phase of the second OFDM signal according to the control value of the phase, the control value being calculated by the phase difference controlling unit.

9. The radio transmitter according to claim 8,
wherein the phase difference controlling unit specifies a first subcarrier included in a frequency domain specified by the notch position information based on the notch position information, and calculates a control value of the phase of the second OFDM signal based on a number of subcarriers included between a second subcarrier using a frequency at an end of a signal band used for transmission of the composite signal and the first subcarrier.

10. A radio receiver receiving first and second OFDM signals from the radio transmitter according to claim 1, the radio transmitter transmitting the first and second OFDM signals carrying the same information, the radio receiver comprising:
a control value calculating unit that calculates a control value of a phase of the second OFDM signal based on a spectrum of a composite signal of the first and second OFDM signals; and
a phase difference controlling unit that notifies the radio transmitter of the control value of the phase, the control value being calculated by the control value calculating unit.

11. The radio receiver according to claim 10, further comprising:
a propagation path estimating unit that recognizes, when receiving the first and second OFDM signals from the radio transmitter, a subcarrier used for transmission of a pilot signal used for correction of an influence of a propagation path of the first and second OFDM signals,
wherein the control value calculating unit calculates a control value of the phase of the second OFDM signal based on a frequency at which a notch in the spectrum of the composite signal of the first and second OFDM signals appears by recognizing a signal strength of the pilot signal in relation to a number of a subcarrier.

12. A radio communication system including a radio transmitter transmitting first and second OFDM signals carrying the same information and a radio receiver receiving the first and second OFDM signals from the radio transmitter, wherein the radio receiver calculates a control value of a phase of the second OFDM signal based on a spectrum of a composite signal of the first and second OFDM signals,
the radio receiver transmits information indicating the control value to the radio transmitter, and
based on the control value, the radio transmitter controls the phase of the second OFDM signal.

13. A radio transmitting method for transmitting first and second OFDM signals carrying the same information, comprising:
calculating a control value of a phase of the second OFDM signal based on a spectrum of a composite signal of the first and second OFDM signals; and
controlling the phase of the second OFDM signal according to the calculated control value of the phase.

14. The radio transmitting method according to claim 13, further comprising:
receiving notch position information representing a frequency at which a notch in the spectrum of the composite signal appears, the notch position information being detected by a radio receiver which has received the first and second OFDM signals; and
calculating a control value of the phase of the second OFDM signal based on the notch position information.
